(19) United States
(12) Patent Application Publication
(10) Pub. No.: US 2001/0002745 A1
(43) Pub. Date: Jun. 7, 2001

(54) Device for height and/or track width adjustment on vehicles for transport of children and/or two-wheel trailers

(76) Inventor: Herbert Weber, Breitbrunn (DE)

Correspondence Address: NIXON & VANDERHYE P.C., 8th Floor, 1100 North Glebe Rd., Arlington, VA, 22201-4714, US

(21) Appl. No.: 09/725,052

(22) Filed: Nov. 29, 2000

(30) Foreign Application Priority Data
Dec. 7, 1999 (DE) 299 21 434.6
Apr. 27, 2000 (DE) 100 20 588.7

(51) Int. Cl. B62D 61/08; B62K 27/12

(52) U.S. Cl. 280/62; 280/204; 280/292; 280/47.18

(57) ABSTRACT

An improved device for height and/or track width adjustment on vehicles for transport of children and/or trailers which can be attached to two-wheel conveyances, with an optionally retrofittable adapter means (27) for height and/or track width adjustment is characterized by the following features

the adapter means (27) has an insert projection (29) which in the installed state leaves the original bearing or axle receiver (19) unchanged in its useful function for anchoring a running wheel (19),

the adapter means (27) has at least one other bearing or axle receiver (19a, 19b) in which a running wheel can be alternatively fixed, and/or

the bearing receiver (19a, 19b) of the adapter means (27) is aligned at an angle to the original bearing or axle receiver (19),

the angled alignment of the bearing or axle receiver (19a, 19b) takes place to the outside towards the running wheel (9) at least slightly rising to increase the effective track width.

The invention relates to a device for height and/or track width adjustment on vehicles for transport of children and/or two-wheel trailers as claimed in the preamble of claim 1.

Basically approaches are known for changing the ratio of the track width to the height of the center of gravity in vehicles for transporting children, for example baby joggers. The vehicle recognizably has different travelling properties depending on the different application, whether it is for example being pushed or whether it is being pulled alternatively by a bicycle.

Thus, for example, for three-wheel vehicles (for example, for the aforementioned baby joggers) it has already been proposed that for the two rear running wheels there be so-called adapters which can be inserted into the existing receiving axle so that the wheels with their axles can be slipped on further to the outside. In this way the track is widened. Upon the change to the originally provided running wheel position however then the adapter must be removed again and stowed separately. In addition, in this case additional handles are necessary.

In addition, however, other approaches are also known which comprise a completely additional axle receiving pipe with two running wheels which run in parallel. Thus it is a very bulky version which comprises additional pipes and an additional clamping device.

The object of this invention is conversely to devise a better approach to a device for changing the height and/or track width on vehicles for transportation of children and/or for two-wheel trailers which, depending on the application, allow easy height and/or track width change.

The object is achieved as claimed in the invention according to the features given in claim 1 and claim 2. Advantageous embodiments of the invention are given in the dependent claims.

The approach as claimed in the invention is characterized by a completely novel adapter with which the track width or the vertical position can be changed.

The adapter as claimed in the invention can be slipped on a trailer-side axle, to which the axle body of a running wheel can also be attached without the originally provided axle receiver being restricted in its useful function by the adapter device. In other words, a running wheel can be attached and fixed on this adapter furthermore in the same position as originally provided.

As claimed in the invention, the adapter has at least one, preferably at least two other axle receivers or axle shafts made in a different relative vertical position in order to fix the running wheel here in a different relative vertical position. If the corresponding axle receivers or axle bodies are made higher, with running wheels of the same size the entire vehicle of course comes to rest lower.

Alternatively or in addition it is provided that at least one, preferably at least two other axle receivers or axle shafts for fixing the running wheel are aligned running at least slightly tilted relative to the horizontal, specifically rising to the outside, so that when viewed from the front side the running wheels are aligned slightly convexly diverging towards the running surface and the road surface. In this way the respective roll-away point on the road surface or running surface comes to rest farther to the outside. This approach is especially favorable since the anchoring points of the running wheels on the axle shaft need not be located further to the outside. When the axle receiver or the axle shaft for anchoring the running wheel however ends somewhat farther to the outside than the axle receiver provided originally on the vehicle, the track width can be further increased to an even greater degree.

In one preferred embodiment of the invention at the same time the track width can also be changed by moving one axle stop.

In one especially preferred embodiment of the invention there is furthermore a receiver for a roll bar on the adapter means.

Other advantages, details and features of the invention follow below from the embodiment shown by the drawings.

FIG. 1 shows a schematic side view of a so-called baby jogger;

FIG. 2a shows a schematic overhead view of the embodiment as shown in FIG. 1;

FIG. 2b shows a corresponding representation to FIG. 2a with a slight deviation such that instead of a front running wheel 11 there is a trailer means or shaft via which the so-called baby jogger can be attached to a bicycle;

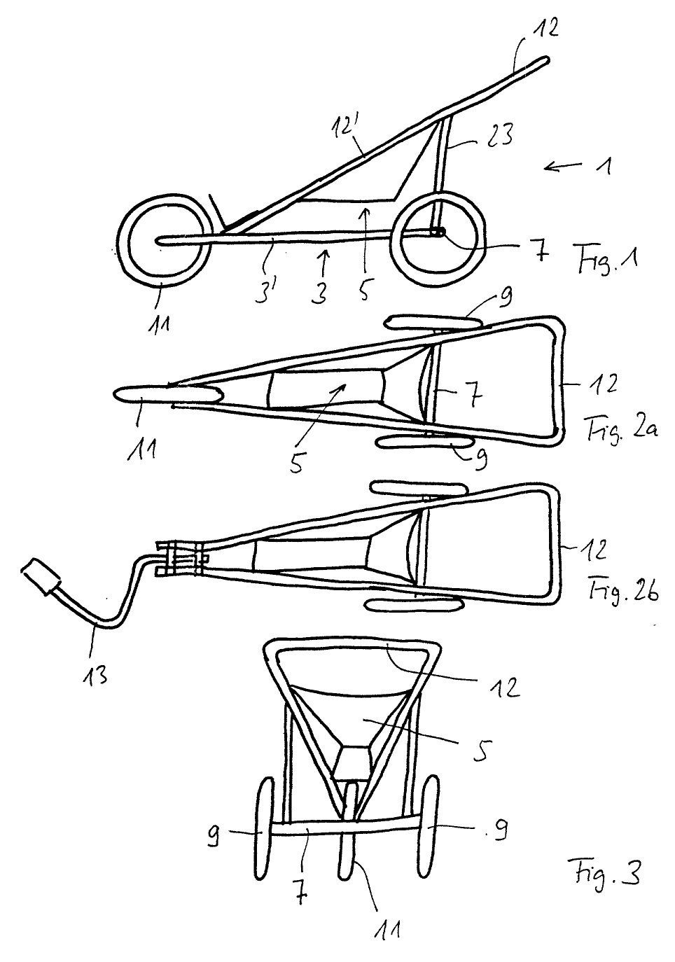

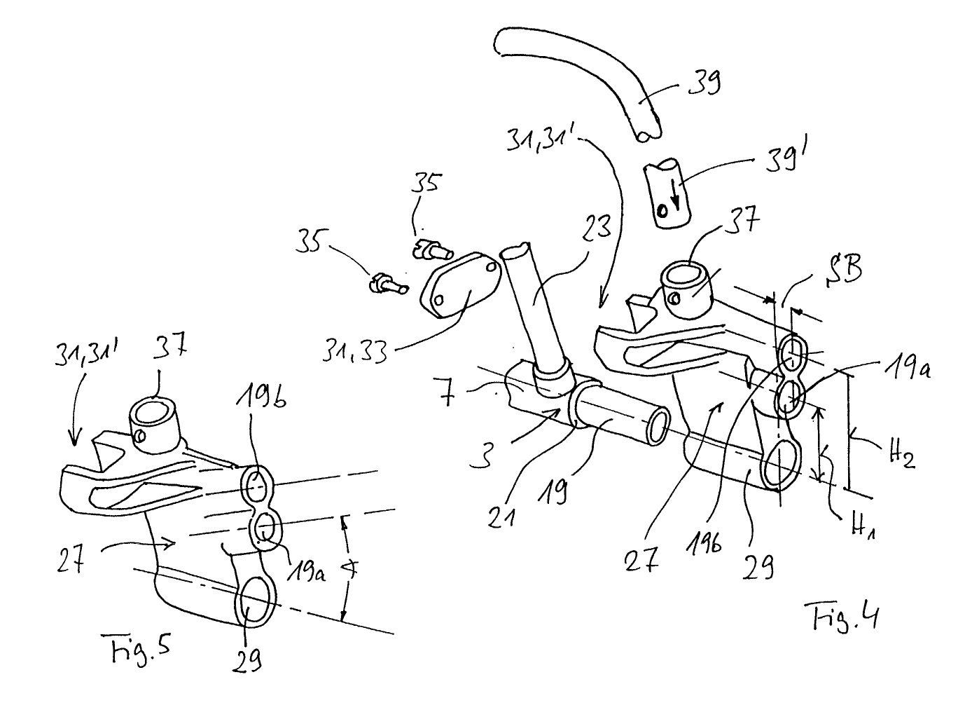

FIG. 3 shows a schematic backward view of the embodiment as claimed in FIGS. 1 and 2;

FIG. 4 shows a representation of the adapter means as claimed in the invention for the right wheel in an exploded perspective view; and

FIG. 5 shows a modified embodiment of the adapter shown in FIG. 4.

FIG. 1 shows a vehicle for transportation of children, i.e. a so-called bicycle trailer or baby jogger 1 which has a frame 3 for a bottom surface or seat arrangement 5, a rear wheel axle 7 with two running wheels 9 located laterally on the outside and in the embodiment shown a third running wheel 11 which lies in the middle on the front side. Via the shaft 13 shown in FIG. 3 for example this vehicle 1 can be attached to a bicycle which is not detailed and can be used as a pullable trailer. The vehicle can however also be pushed via a handle 12.

FIG. 2b also shows schematically that the front running wheel 11 is easily dismounted if necessary and at this location the shaft 13 can be easily attached as the connecting element to a bicycle or other two-wheel conveyance or pulling vehicle. Optionally the shaft can however also be attached such that the running wheel 11 need not be dismounted when the shaft is attached.

The handle is connected via lateral handle rods 12′ to the bottom frame 3, the actual frame 3 being formed from at least two lateral tubular carrier elements 3′ which are to run in this embodiment from back to front on one another. The handle rods 12′ which are connected to the handle 12 are connected via backward vertical supports 23 to the bottom frame or the non-turning outer holding part of the wheel axle 7.

The running wheels 9 conventionally have an axle journal 17 via which they can be inserted and fixed on a corresponding bearing receiver 19 of the tubular wheel axle 7. Below it is assumed that the running wheel 9 which is not shown individually in detail is provided with a corresponding axle journal 17 which can be inserted into a corresponding tubular bearing receiver 19 and can be secured by other safety measures which are not detailed, but are known, against intentional removal.

For example, FIG. 4 shows the right-hand end of the wheel axle 7 with the corresponding bearing axle receiver 19 into which conventionally a running wheel 9 with an axle journal 7 is inserted and secured.

In the embodiment shown the cylindrical bearing receiver 19 is provided offset to its free insertion end with an annular projection or a stop 21 on which the bearing receiver 19 passes into the frame 3. But FIG. 4 also shows that for example in the vicinity of this projection or stop 21 moreover a tube 23 which runs transversely to the wheel axle 7 can be attached which for example uses a side support or a rest for the framing of the bottom surface 5 or for a pushing handle.

But FIG. 4 furthermore shows an adapter means 27 which comprises an insert projection 29 which lies underneath. The inside diameter of this insert projection 29 is matched to the outside diameter of the bearing receiver 19 and can be slipped on there.

The adapter means 27 thus comprises a fixing means 31 which is higher than the insert projection 29 and with which it can be fixed securely relative to the wheel axle 7 without the capacity to turn. This fixing means 31 comprises forking 31′ which in the seated state laterally surrounds the aforementioned tube 23 which is used as the stop and which likewise cannot be turned relative to the wheel axle 7 and by means of an opposing plate which reaches over the pipe 23 on the opposite side can be secured by for example two screws 35 being turned through holes in the opposing plate 33 into the fork projections of the forking 31′.

Since the insert projection 29 is not inserted into the bearing receiver 19, but reaches over the bearing receiver on the outside and is dimensioned in its axial length such that it ends flush at least roughly with the bearing receiver 19 provided from the factory, this offers the possibility of fixing in the conventional position and inserting the running wheel 9 with the corresponding axle journal in spite of the installed adapter 27 in the area of the original bearing receiver 19 in the conventional manner, as provided originally.

The adapter means 27 however has two other higher bearing receivers 19a and 19b which are aligned parallel to the bearing receiver 19, i.e. generally horizontally, and end preferably farther to the outside (viewed from the vertical middle lengthwise plane of the vehicle) by an amount SB. Since also on the opposite side a mirror-image adapter is installed, this means that in this way the track width can be increased by twice the amount SB, specifically on each side of the vehicle by the amount SB.

Depending on whether the running wheel is inserted on the car receiver 19a or 19b, the center of gravity is lower according to the amount H₁ and H₂.

Finally, FIG. 4 furthermore shows that there is an insertion receiver 37 into which for example the end 39′ of a roll bar 39 can be inserted. The end of the roll bar 39 can be fixed on the adapter 27 through a hole 41 in the insertion receiver 37.

FIG. 5 shows a different adapter which differs from the one in FIG. 4 in that the two bearing receivers 19a, 19b do not run in parallel, i.e. generally horizontal alignment to the bearing receiver 19 or to the plug attachment 29, but rising to the outside slightly inclined at an angle α. In this way the camber of the wheels is changed according to the angle α. Depending on the diameter of the running wheel thus the roll-away point on the running surface of the running wheel comes to rest further to the outside, even when the free plug ends of the bearing receivers 19a and 19b end at the same lateral distance from the center lengthwise plane of the vehicle 1 as the bearing receiver 19. If for the bearing receivers 19a, 19b, nevertheless as in the embodiment as shown in FIG. 4, there is an increase in the track width SB at the height of the bearing receivers, this contributes to an increase of the genuinely attainable track width with consideration of the altered camber of the wheels.

The embodiment has been explained for the case in which the running wheels 9 for example are provided with an axle journal 7 which can be inserted in the corresponding axle receivers 19 and 19a, 19b, etc. and there can be fixed or clamped there by suitable measure. Here the axle journal is conventionally made so long that when the axle journal is fixed in the bearing receiver 19 provided from the factory the running wheel does not collide with the bearing receivers 19a, 19b which project laterally somewhat farther to the outside.

1. Device for height and/or track width adjustment on vehicles for transport of children and/or trailers which can be attached to two-wheel conveyances, with an optionally retrofittable adapter means (27) for height and/or track width adjustment, characterized by the following features
the adapter means (27) has an insert projection (29) which in the installed state leaves the original bearing or axle receiver (19) unchanged in its useful function for anchoring a running wheel (19), and
the adapter means (27) has at least one other bearing or axle receiver (19a, 19b) in which a running wheel can be alternatively fixed.

2. Device as claimed in the preamble of claim 1, especially as claimed in claim 1, characterized by the following features
the bearing receiver (19a, 19b) of the adapter means (27) is aligned at an angle to the original bearing or axle receiver (19),
the angled alignment of the bearing or axle receiver (19a, 19b) takes place to the outside towards the running wheel (9) at least slightly rising to increase the effective track width.

3. Device as claimed in claim 1 or 2, wherein on the adapter (27) at least two axle receivers (19a, 19b) are made at a different relative vertical height position.

4. Device as claimed in claim 2 or 3, wherein the at least two bearing or axle receivers (19a, 19b) formed on the adapter (27) are aligned parallel to one another and preferably at an angle (α) relative to the original bearing or axle receiver (19) for the purpose of increasing the track width.

5. Adapter means (27) as claimed in one of claims 1 to 4, wherein the adapter means (31) comprises a fixing means (31) via which the adapter means (27) is held at least indirectly, detachably without the capacity to move and turn, on the frame (3) of the vehicle (1).

6. Device as claimed in one of claims 1 to 5, wherein the adapter means (27) can be retrofitted.

7. Device as claimed in one of claims 1 to 5, wherein the adapter means (27) represents part of the vehicle frame (3).

8. Device as claimed in one of claims 1 to 7, wherein the adapter means (47) has another projection (37) on which attachment parts, preferably a safety roll bar (39), can be mounted.
